(19) United States
(12) Patent Application Publication
(10) Pub. No.: US 2019/0266261 A1
(43) Pub. Date: Aug. 29, 2019

(54) SYSTEMS AND METHODS FOR AUTOMATED DOCUMENTATION AND OPTIMIZATION OF A MANUFACTURING PROCESS

(71) Applicant: GM Global Technology Operations LLC, Detroit, MI (US)

(72) Inventors: Arkadi VINNIK, Ann Arbor, MI (US); John B. KATONA, JR., Holly, MI (US)

(73) Assignee: GM Global Technology Operations LLC, Detroit, MI (US)

(21) Appl. No.: 15/904,733

(22) Filed: Feb. 26, 2018

(51) Int. Cl. G06F 17/30; G06T 7/00; G06Q 50/04

(52) U.S. Cl. CPC G06F 17/30259; G06T 2207/30164; G06Q 50/04; G06T 7/001

(57) ABSTRACT

A camera is configured to, at a predetermined rate, capture images of an assembler during assembly of a plurality of components into an assembly using one or more tools. A first database is stored in memory and includes: imaging data associated with known components; and unique part numbers of the known components, respectively. A component module is configured to: based on the imaging data associated with the known components and portions of the images including one of the components, identify the one of the components as one of the known components; and determine the unique part number associated with the one of the known components. An assembly document module is configured to: add the unique part number associated with the one of the known components to an assembly document including instructions for assembling the plurality of components into the assembly; and store the assembly document in memory.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to manufacturing processes and more particularly to systems and methods for computer based documentation of details of manufacturing processes derived via captured images.

One type of manufacturing process involves use of an assembly line where parts are sequentially added to a not yet completed product until a final product is produced. The not yet completed product is normally moved from workstation to workstation of the assembly line, and one or more components are added at each workstation.

Assembly lines may be used to produce various different types of finished products, such as residential appliances, electronic devices (e.g., cell phones, tablets, laptop computers, etc.), automobiles, and other types of finished products. By moving the not yet completed products from workstation to workstation and the addition of the same components at each workstation, the finished product may be assembled quickly and accurately.

### SUMMARY

In a feature, a manufacturing process documentation system includes a camera configured to, at a predetermined rate, capture images of an assembler during assembly of a plurality of components into an assembly using one or more tools. A first database is stored in memory and includes: imaging data associated with known components; and unique part numbers of the known components, respectively. A component module is configured to: based on the imaging data associated with the known components and portions of the images including one of the components, identify the one of the components as one of the known components; and determine the unique part number associated with the one of the known components. An assembly document module is configured to: add the unique part number associated with the one of the known components to an assembly document including instructions for assembling the plurality of components into the assembly; and store the assembly document in memory.

In further features, the assembly document module is configured to identify a portion of the assembly document that is associated with the one of the components and to replace one or more words included in the portion with the unique part number associated with the one of the known components.

In further features, the component module is further configured to: based on the imaging data associated with the known components and portions of the images including a second one of the components, identify the second one of the components as a second one of the known components; and determine the unique part number associated with the second one of the known components. The assembly document module is further configured to add the unique part number associated with the second one of the known components to the assembly document including instructions for assembling the plurality of components into the assembly.

In further features, a second database is stored in memory and includes: imaging data associated with known tools; and unique tool descriptions of the known tools, respectively. A tool module is configured to: based on the imaging data associated with the known tools and portions of the images including one of the tools, identify the one of the tools as one of the known tools; and determine the unique tool description associated with the one of the known tools. The assembly document module is further configured to add the unique tool description associated with the one of the known tools to the assembly document including the instructions for assembling the plurality of components into the assembly.

In further features, the assembly document module is configured to identify a portion of the assembly document that is associated with the one of the components and to replace one or more words included in the portion with the unique tool description associated with the one of the known tools.

In further features, the tool module is further configured to: based on the imaging data associated with the known tools and portions of the images including a second one of the tools, identify the second one of the tools as a second one of the known tools; and determine the unique tool description associated with the second one of the known tools. The assembly document module is further configured to add the unique tool description associated with the second one of the known tools to the assembly document including instructions for assembling the plurality of components into the assembly.

In further features, an order module is configured to, based on the images, determine an order that the assembler assembled the components into the assembly. The assembly document module is configured to add the order to the assembly document including instructions for assembling the components into the assembly.

In further features, a position module is configured to, based on the images, determine a position of the assembler during assembly of the one of the components. The assembly document module is configured to add the position to the assembly document including instructions for assembling the components into the assembly.

In further features, a position module is configured to, based on the images, determine a position of one of the tools during assembly of the one of the components using the one of the tools. The assembly document module is configured to add the position to the assembly document including instructions for assembling the components into the assembly.

In further features, a position module is configured to, based on the images: determine a first position of the assembler during assembly of the one of the components; and determine a second position of one of the tools during assembly of the one of the components using the one of the tools. The assembly document module is configured to add the first position and the second position to the assembly document including instructions for assembling the components into the assembly.

In further features, a second database is stored in memory and includes: imaging data associated with known tools; and unique tool descriptions of the known tools, respectively. A tool module is configured to: based on the imaging data associated with the known tools and portions of the images including one of the tools, identify the one of the tools as one of the known tools; and determine the unique tool description associated with the one of the known tools. An order module is configured to, based on the images, determine an order that the assembler assembled the components into the assembly. The assembly document module is further configured to add the unique tool description associated with the one of the known tools and the order to the assembly document including the instructions for assembling the plurality of components into the assembly.

In further features, an output module is configured to display the assembly document on a display located at a workstation of the assembler.

In further features, an output module is configured to print the assembly document from a printer.

In further features, a second camera is configured to, at a predetermined rate, capture second images of a second assembler during assembly of a second plurality of components into a second assembly using a second one or more tools. The component module is further configured to: based on the imaging data associated with the known components and portions of the second images including one of the second plurality of components, identify the one of the second plurality of components as a second one of the known components; and determine the unique part number associated with the second one of the known components. The assembly document module is further configured to: add the unique part number associated with the second one of the known components to a second assembly document including second instructions for assembling the second plurality of components into the second assembly; and store the second assembly document in memory.

In further features, a second camera is configured to, at a predetermined rate, capture second images of the assembler during assembly of the plurality of components into the assembly using the one or more tools. The component module is configured to identify the one of the components as one of the known components based on: the imaging data associated with the known components; the portions of the images including the one of the components; and second portions of the second images including the one of the components.

In a feature, a method includes: by a camera, at a predetermined rate, capturing images of an assembler during assembly of a plurality of components into an assembly using one or more tools; storing, in a first database stored in memory: imaging data associated with known components; and unique part numbers of the known components, respectively; based on the imaging data associated with the known components and portions of the images including one of the components, identifying the one of the components as one of the known components; determining the unique part number associated with the one of the known components; adding the unique part number associated with the one of the known components to an assembly document including instructions for assembling the plurality of components into the assembly; and storing the assembly document in memory.

In further features, the method further includes: identifying a portion of the assembly document that is associated with the one of the components; and replacing one or more words included in the portion with the unique part number associated with the one of the known components.

In further features, the method further includes: based on the imaging data associated with the known components and portions of the images including a second one of the components, identifying the second one of the components as a second one of the known components; determining the unique part number associated with the second one of the known components; and adding the unique part number associated with the second one of the known components to the assembly document including instructions for assembling the plurality of components into the assembly.

In further features, the method further includes: storing, in a second database stored in memory: imaging data associated with known tools; and unique tool descriptions of the known tools, respectively; based on the imaging data associated with the known tools and portions of the images including one of the tools, identifying the one of the tools as one of the known tools; determining the unique tool description associated with the one of the known tools; and adding the unique tool description associated with the one of the known tools to the assembly document including the instructions for assembling the plurality of components into the assembly.

In further features, the method further includes: based on the images, determining a position of the assembler during assembly of the one of the components; and adding the position to the assembly document including instructions for assembling the components into the assembly.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example vehicle system;

FIG. 2 is a functional block diagram of an example assembly line;

FIG. 3 is a functional block diagram of an example of a first workstation of a manufacturing process;

FIG. 4 is a functional block diagram of an example implementation of an assembly documentation system including a camera and a server; and

FIG. 5 is a flowchart depicting an example method creating and updating an assembly document for a workstation of a manufacturing process using images from a camera at the workstation.

In the drawings, reference numbers may be reused to identify similar and/or identical elements.

### DETAILED DESCRIPTION

A vehicle includes a large number of individual (physical) components (or parts) that are assembled together to build the vehicle. For example, a large number of components are assembled together to build an internal combustion engine. A large number of components are assembled together to build a transmission of a vehicle. A large number of components are assembled together to build a chassis of a vehicle. A large number of components are assembled together to build an interior of a passenger cabin of a vehicle.

The components of a vehicle are added in a sequence by assemblers along an assembly line to build the vehicle. The assemblers may include, for example, humans, robots, or a combination of humans and robots. One or more details as to components (e.g., part numbers), tools to be used, order of assembly, and locations for assembly, assembler, and tools may not be included in assembly documentation. Even if all of the details are included in assembly documentation, the assembly documentation may not be standardized or formalized for each workstation or assembler.

According to the present application, a camera captures images at a workstation as one or more assemblers assemble components to produce an assembly. Using the images captured during the assembly, a module creates or updates an assembly document detailing the assembly to be performed at the workstation.

For example, the component(s) may be identified by comparing visual attributes of the component(s) captured in the images with virtual models of components stored in a component/part database. Part numbers of identified components are added to the document for the workstation. Characteristics (e.g., type of tool, length, number and length of extensions, component interface type or size, etc.) of one or more tools used to assemble the components may also be identified by comparing visual attributes of any tools used by the assembler(s) captured in the images with virtual models of components stored in a tool database. The characteristics of the tool(s) used are also added to the document for the workstation.

An order of assembly of the components may also be identified from the images. The order of the assembly of the components is added to the document for the workstation. Locations and orientations of the assembler(s) and the tool(s) used may also be identified from the images. The locations and orientations of the assembler(s) and the tool(s) used are added to the document for the workstation.

The above accurately and automatically creates or updates formal assembly documentation. The documentation can also be automatically updated, for example, if an assembler makes one or more modifications. The formal assembly documentation should improve throughput and efficiency of the assembly line. While the example of assembling a vehicle is provided, the present disclosure is also applicable to assembly of other types of objects.

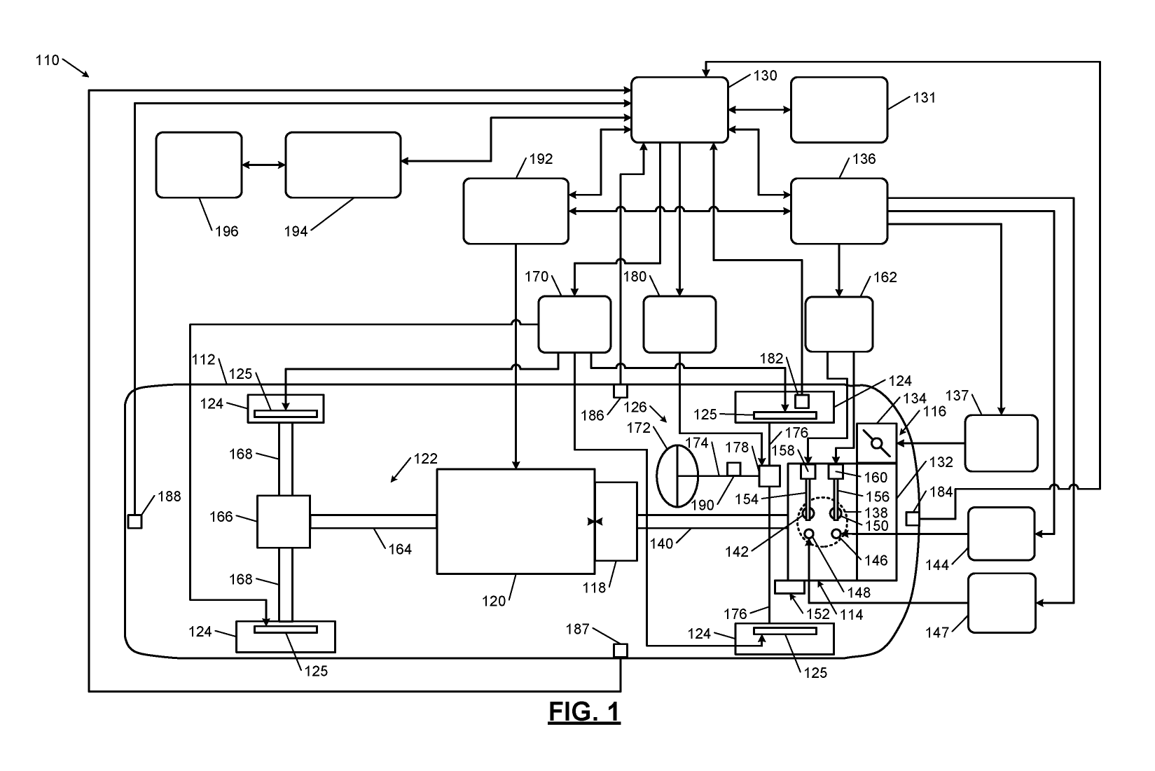

FIG. 1 includes a functional block diagram of an example vehicle system. A vehicle 110 includes a vehicle body 112, an engine 114, an intake system 116, a torque converter 118, a transmission 120, a driveline 122, wheels 124, mechanical (friction) brakes 125, and a steering system 126. The vehicle 110 may be autonomous, semi-autonomous, or non-autonomous. The vehicle 110 may be a shared vehicle (e.g., part of a ride sharing system) or a non-shared vehicle.

The engine 114 combusts an air/fuel mixture to produce drive torque for the vehicle 110. The amount of torque input to the transmission 120 is controlled based on a driver input and/or a first input from a driving control module (DCM) 130. The driver input may be a signal indicating a position of an accelerator pedal. The first input from the DCM 130 may be a target vehicle acceleration.

The DCM 130 may adjust the target vehicle acceleration, for example, to maintain a target vehicle speed, to maintain a predetermined following distance, and/or to prevent contact between the vehicle and one or more objects around the vehicle 110. The DCM 130 may determine the target vehicle speed based on the location of the vehicle 110 and a government speed limit for the road on which the vehicle 110 is travelling. The DCM 130 may determine the speed limit, for example, based on an input received from a global positioning system (GPS) module 131 or by identifying the speed limit posted on a speed limit sign from an image captured using a camera. The GPS module 131 includes a transceiver for communicating with a GPS satellite.

Air is drawn into the engine 114 through the intake system 116. The intake system 116 includes an intake manifold 132 and a throttle valve 134. The throttle valve 134 may include a butterfly valve having a rotatable blade. An engine control module (ECM) 136 controls a throttle actuator module 137, which regulates opening of the throttle valve 134 to control the amount of air drawn into the intake manifold 132.

Air from the intake manifold 132 is drawn into cylinders of the engine 114. While the engine 114 may include multiple cylinders, for illustration purposes a single representative cylinder 138 is shown. For example only, the engine 114 may include 2, 3, 4, 5, 6, 8, 10, and/or 12 cylinders. The ECM 136 may deactivate some of the cylinders, which may improve fuel economy under certain engine operating conditions.

The engine 114 may operate using a four-stroke cycle. The four strokes, described below, are named the intake stroke, the compression stroke, the combustion stroke, and the exhaust stroke. During each revolution of a crankshaft 140, two of the four strokes occur within the cylinder 138. Therefore, two crankshaft revolutions are necessary for the cylinder 138 to experience all four of the strokes.

During the intake stroke, air from the intake manifold 132 is drawn into the cylinder 138 through an intake valve 142. The ECM 136 controls a fuel actuator module 144, which regulates fuel injections performed by a fuel injector 146 to achieve a target air/fuel ratio. Fuel may be injected into the intake manifold 132 at a central location or at multiple locations, such as near the intake valve 142 of each of the cylinders. In various implementations, fuel may be injected directly into the cylinders or into mixing chambers associated with the cylinders. The fuel actuator module 144 may halt injection of fuel to cylinders that are deactivated.

The injected fuel mixes with air and creates an air/fuel mixture in the cylinder 138. During the compression stroke, a piston (not shown) within the cylinder 138 compresses the air/fuel mixture. The engine 114 may be a compression-ignition engine, in which case compression in the cylinder 138 ignites the air/fuel mixture. Alternatively, the engine 114 may be a spark-ignition engine, in which case a spark actuator module 147 energizes a spark plug 148 to generate a spark in the cylinder 138 based on a signal from the ECM 136, which ignites the air/fuel mixture. The timing of the spark may be specified relative to the time when the piston is at its topmost position, referred to as top dead center (TDC).

The spark actuator module 147 may be controlled by a spark timing signal specifying how far before or after TDC to generate the spark. Because piston position is directly related to crankshaft rotation, operation of the spark actuator module 147 may be synchronized with crankshaft angle. In various implementations, the spark actuator module 147 may halt provision of spark to deactivated cylinders. Spark plugs are omitted in some types of engines.

During the combustion stroke, combustion of the air/fuel mixture drives the piston down, thereby driving the crankshaft 140. The combustion stroke may be defined as the time between the piston reaching TDC and the time at which the piston returns to bottom dead center (BDC). During the exhaust stroke, the piston begins moving up from BDC and expels the byproducts of combustion through an exhaust valve 150. The byproducts of combustion are exhausted from the vehicle via an exhaust system 152.

The intake valve 142 may be controlled by an intake camshaft 154, while the exhaust valve 150 may be controlled by an exhaust camshaft 156. In various implementations, multiple intake camshafts (including the intake camshaft 154) may control multiple intake valves (including the intake valve 142) for the cylinder 138 and/or may control the intake valves (including the intake valve 142) of multiple banks of cylinders (including the cylinder 138). Similarly, multiple exhaust camshafts (including the exhaust camshaft 156) may control multiple exhaust valves for the cylinder 138 and/or may control exhaust valves (including the exhaust valve 150) for multiple banks of cylinders (including the cylinder 138).

The time at which the intake valve 142 is opened may be varied with respect to piston TDC by an intake cam phaser 158. The time at which the exhaust valve 150 is opened may be varied with respect to piston TDC by an exhaust cam phaser 160. A valve actuator module 162 may control the intake and exhaust cam phasers 158, 160 based on signals from the ECM 136. When implemented, variable valve lift may also be controlled by the valve actuator module 162.

The valve actuator module 162 may deactivate the cylinder 138 by disabling opening of the intake valve 142 and/or the exhaust valve 150. The valve actuator module 162 may disable opening of the intake valve 142 by decoupling the intake valve 142 from the intake cam phaser 158. Similarly, the valve actuator module 162 may disable opening of the exhaust valve 150 by decoupling the exhaust valve 150 from the exhaust cam phaser 160. In various implementations, the valve actuator module 162 may control the intake valve 142 and/or the exhaust valve 150 using devices other than camshafts, such as electromagnetic or electrohydraulic actuators.

The ECM 136 adjusts the position of the throttle valve 134, the amount and/or timing of fuel injections performed by the fuel injector 146, the timing at which spark is generated by the spark plug 148, and/or the timing at which the intake and exhaust valves 142 and 150 are opened to achieve a target torque output of the engine 114. The ECM 136 determines the target engine torque based on the driver input and/or the first input from the DCM 130. The ECM 136 may determine whether to determine the target engine torque based on the driver input or the first input based on a second input from the DCM 130. The DCM 130 may control whether the ECM 136 uses the driver input or the first input to determine the target engine torque based on whether the driver's foot is on the accelerator pedal. The DCM 130 may determine that the driver's foot is on the accelerator pedal when the accelerator pedal position indicates a pedal depression level that is greater than a predetermined amount.

In some vehicles, one or more electric motors may be implemented in addition to the engine 114 or in place of the engine 114. The ECM 136 may control torque output of the one or more electric motors based on the target engine torque.

Torque output by the engine 114 (via the crankshaft 140) and/or one or more electric motors is transferred to the transmission 120, through the driveline 122, and to the wheels 124. The driveline 122 includes a drive shaft 164, a differential 166, and axle shafts 168. The torque converter 118, the transmission 120, and the differential 166 increase or decrease torque by several gear ratios to provide axle torque at the axle shafts 168. The axle torque rotates the wheels 124, which causes the vehicle 110 to accelerate in a forward or rearward direction.

The friction brakes 125 are mounted to the wheels 124. The friction brakes 125 resist (slow) rotation of the wheels 124 when the friction brakes 125 are applied. The friction brakes 125 may include drum brakes and/or disc brakes, and may include electrohydraulic actuators and/or electromechanical actuators that press a brake pad against a brake disc and/or drum when the friction brakes 125 are applied.

A brake actuator module 170 applies the friction brakes 125 based on a brake pedal position and/or a signal from the DCM 130. The friction brakes 125 may be independently applied at different levels. The DCM 130 may apply the friction brakes 125, for example, to maintain the target vehicle speed, to maintain the predetermined following distance, and/or to prevent the vehicle from contacting an object.

The steering system 126 selectively turns the front wheels 124, thereby turning the vehicle 110. The steering system 126 includes a steering wheel 172, a steering column 174, one or more steering linkages 176, and a steering actuator 178. A driver may rotate the steering wheel 172 to turn the vehicle 110 left or right or to input a request to turn the vehicle 110 left or right. The steering column 174 is coupled to the steering wheel 172 so that the steering column 174 rotates when the steering wheel 172 is rotated. The steering column 174 may also be coupled to the steering linkages 176 so that rotation of the steering column 174 causes translation of the steering linkages 176. The steering linkages 176 are coupled to the front wheels 124 so that translation of the steering linkages 176 turns the wheels 124.

The steering actuator 178 is coupled to the steering linkages 176 and translates the steering linkages 176, thereby turning the front wheels 124. In various implementations, the steering actuator 178 may be an electrohydraulic and/or electromechanical actuator. In implementations where the steering column 174 is coupled to the steering linkages 176, such as power steering systems, the steering actuator 178 may reduce the amount of effort that the driver must exert to turn the vehicle 110. In various implementations, the steering column 174 may not be coupled to the steering linkages 176, and the steering actuator 178 alone may translate the steering linkages 176. Steering systems where the steering column 174 is not coupled to the steering linkages 176 may be referred to as a steer-by-wire system.

A steering actuator module 180 actuates the steering actuator 178 based on a steering signal from the DCM 130. The DCM 130 may set the steering signal based on the angular position of the steering wheel 172. In various implementations, the DCM 130 may set the steering signal based on one or more other inputs. For example, the DCM 130 may set the steering signal to navigate the vehicle according to a target path. The DCM 130 may set the target path to maintain the vehicle 110 between lane lines under some circumstances, to change lanes, to avoid contacting objects, and/or to navigate the vehicle 110 from its present location to a target location.

One or more wheel speed sensors 182 are mounted to one or more of the wheels 124 and measures the speed of wheels 124, respectively. For example, one wheel speed sensor may be provided for each wheel and measure that wheels wheel speed.

A forward facing camera 184 captures images within a predetermined field of view (FOV) in front of the vehicle 110. The forward facing camera 184 may be located, for example, in a front fascia of the vehicle 110. The forward facing camera 184, however, may be located elsewhere, such as with a rear view mirror inside of a front wind shield of the vehicle or at another suitable location to capture images in front of the vehicle 110.

Side facing cameras 186 and 187 are mounted to the left and right sides of the vehicle body 112 and generate images within predetermined FOVs on the left and right sides of the vehicle 110, respectively. A rear facing camera 188 captures images within a predetermined field of view (FOV) behind the vehicle 110. While the example of forward facing, side facing, and rear facing cameras are shown and described, one or more other cameras may also be included. Also, while the example of forward facing, side facing, and rear facing cameras are shown and described, the vehicle may additionally or alternatively include one or more other types of sensors that analyze and identify objects around the vehicle, such as light detection and radar (LIDAR) sensors, sonar sensors, radar sensors, and/or one or more other types of sensors.

An accelerometer may be mounted to (e.g., the rear of) the vehicle body 112 and measures the lateral, longitudinal, and/or vertical acceleration of the vehicle 110. The accelerometer may include a triaxial accelerometer, a dual-axis accelerometer, and/or one or more single-axis accelerometers. In one example, the accelerometer is a dual-axis accelerometer that measures the lateral and longitudinal acceleration of the vehicle 110.

A steering wheel angle sensor 190 measures the angular position of the steering wheel 172 relative to a predetermined position. The predetermined position may correspond to a location where the vehicle should (or does) travel straight along a longitudinal axis of the vehicle. The steering wheel angle sensor 190 may be mounted to the steering column 174 and may include, for example, a Hall Effect sensor that measures the angular position of a shaft that is disposed within the steering column 174 and rotatably coupled to the steering wheel 172.

A transmission control module (TCM) 192 shifts gears of the transmission 120 based on operating conditions of the vehicle 110 and a predetermined shift schedule. The operating conditions may include the speed of the vehicle 110, a target acceleration of the vehicle 110, and/or a target torque output of the engine 114. The TCM 192 may determine a vehicle speed based on wheel speeds measured using the wheel speed sensors 182. For example, the TCM 192 may determine the vehicle speed based on an average of the wheel speeds or an average of speeds of undriven (i.e., non-driven) wheels of the vehicle. The TCM 192 may receive the target vehicle acceleration and/or the target engine torque from the DCM 130 and/or the ECM 136. The ECM 136 may communicate with the TCM 192 to coordinate shifting gears in the transmission 120. For example, the ECM 136 may reduce engine torque during a gear shift.

The vehicle 110 also includes a communications module 194 including one or more transceivers that wirelessly receive information from and transmit information via one or more antennas 196 of the vehicle. Examples of transceivers include, for example, cellular transceivers, Bluetooth transceivers, WiFi transceivers, satellite transceivers, and other types of transceivers.

While the example of the vehicle 110 is provided, vehicles may include one or more other components not shown and described. Vehicles may additionally or alternatively omit one or more of the above components.

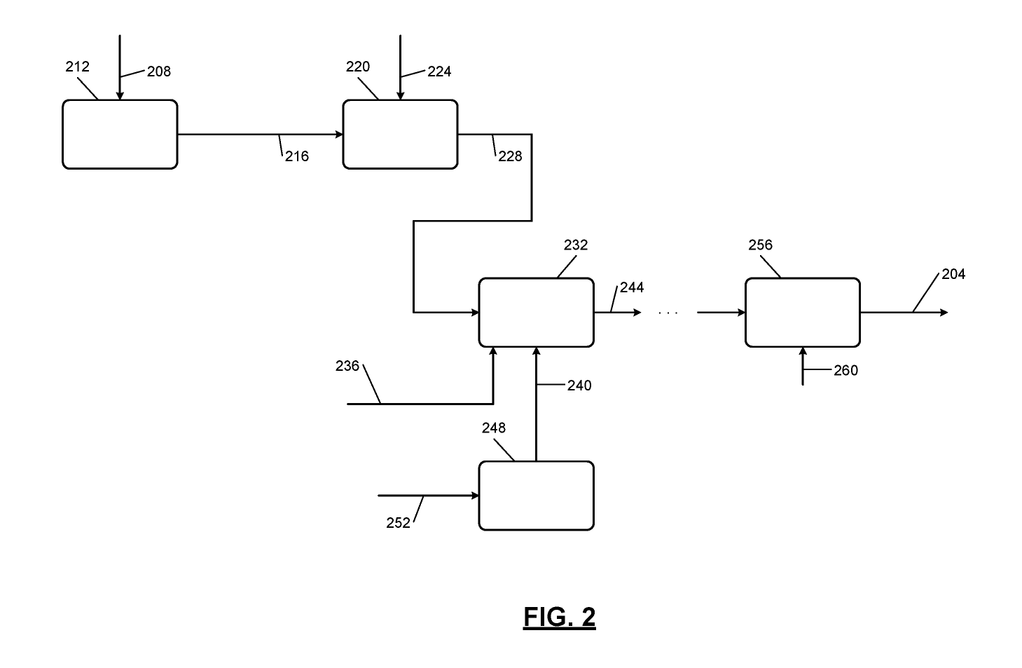

FIG. 2 includes a functional block diagram of an example vehicle manufacturing process. Components are assembled at a plurality of workstations in a predetermined order to produce vehicles, such as vehicle 204. At each workstation, a plurality of components are added to a received assembly or a group of one or more assemblies are combined.

For example, a first set of components 208 is assembled at a first workstation 212 to produce a first assembly 216. At a second workstation 220, a second set of components 224 are added to the first assembly 216 to produce a second assembly 228.

At a third workstation 232, a third set of components 236 are added to the second assembly 228 and a third assembly 240 to produce a fourth assembly 244. At a fourth workstation 248, a fourth set of components 252 are assembled to produce the third assembly 240. The presence of additional workstations is illustrated in FIG. 2 by the presence of ellipsis ( . . . ). Finally, at an N-th workstation 256, a set of components 260 are added to produce the (finished) vehicle 204. While FIG. 2 provides an example of workstations, the present disclosure is also applicable to additional and other arrangements of workstations. Also, while the example of vehicle manufacturing is provided, the present disclosure is also applicable to manufacturing of components of vehicles (e.g., engines, transmissions, etc.) and manufacturing of other types of objects.

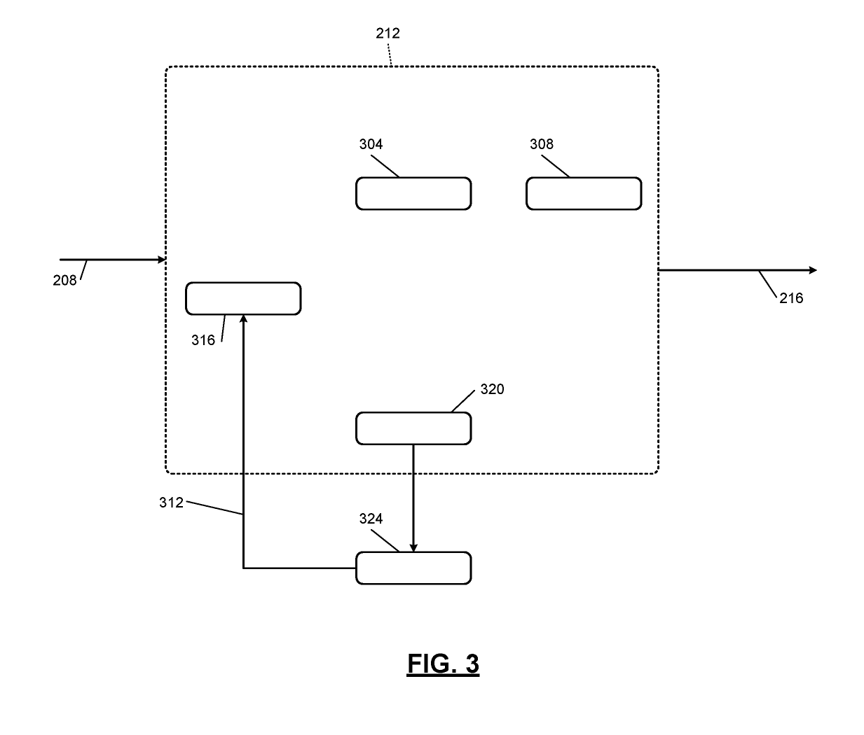

FIG. 3 includes a functional block diagram of the example of the first workstation 212. An assembler 304 assembles the first set of components 208 using one or more of tools 308 to produce the first assembly 216. The assembler 304 may be, for example, a human or a robot.

The assembler 304 assembles the first set of components 208 in an order that is, for example, learned by the assembler 304 at the first workstation 212, trained to the assembler 304 based on an assembly document (file) 312 for the first workstation 212, read by the assembler 304 from the assembly document 312 for the first workstation 212, or programmed into the assembler 304 based on the assembly document 312. In various implementations, the assembly document 312 may be displayed at the first workstation 212 on one or more displays, such as display 316. While the example of one assembler is provided, two or more assemblers may assemble the first set of components 208 to produce the first assembly 216.

Initially, the assembly document 312 may not include one or more pieces of information. For example, the assembly document 312 may include a descriptive shape of one the components 208 and not a part number of the one of the components 208. Additionally or alternatively, the assembly document 312 may not include an identification of specific ones of the tools 308 to use to assemble two of the components 208 together. Additionally or alternatively, the assembly document 312 may not include an order for assembling the components 208. Additionally or alternatively, the assembly document 312 may not include a position of the assembler 304, a position of one or more of the tools 308, or a position of one or more of the components 208 during the assembly of the components 208. Additionally or alternatively, the assembly document 312 may not include one or more other types of information that are pertinent to the assembly of the first set of components 208 to produce the first assembly 216.

A camera 320 captures images of the assembler 304 assembling the first set of components 208 using one or more of the tools 308 to produce the first assembly 216. The camera 320 is positioned such that the assembler 304 assembles the first set of components 208 within a field of view (FOV) of the camera 320. While the example of a single camera is discussed, two or more cameras may be used to capture images of the assembler 304 assembling the first set of components 208 using the one or more of the tools 308 to produce the first assembly 216. Also, while the example of cameras is provided, one or more other types of optical recognition devices may be used in addition to one or more cameras or as an alternative. Examples of other types of optical recognition devices include scanners, sensors, and other types of devices.

A server 324 or another type of computing device receives a stream of the images from the camera 320. The server 324 may also receive images from cameras of one or more other workstations or all workstations of a manufacturing process.

If the assembly document 312 is not already stored for the first workstation 212, the server 324 creates the assembly document 312 for the first workstation 212 based on information determined from the images from the camera 320 during assembly of the first set of components 208 by the assembler 304 to produce the first assembly 216. If the assembly document 312 is already stored for the first workstation 212, the server 324 updates the assembly document 312 (or creates a new version of the assembly document 312 for the first workstation 212) based on information determined from the images from the camera 320 during assembly of the first set of components 208 by the assembler 304 to produce the first assembly 216.

For example, if the assembly document 312 does not include a part number of one of the components 208 but includes a descriptive shape of the one of the components 208, the server 324 compares a shape of the one of the components 208 captured in at least one of the images with shapes of known components stored in a database. The respective part numbers of the known components are also stored in the database. If the shape of the one of the components 208 is the same as a shape of a known component stored in the database, the server 324 may add the part number of the one of the components 208 to the assembly document 312. In various implementations, the server 324 may replace the descriptive shape of the one of the components 208 with the part number of the one of the components 208. In various implementations, the server 324 may read the part number of the one of the components 208 from an image from the camera 320.

If the assembly document 312 does not include an identification of specific ones of the tools 308 to use to assemble two of the components 208 together, the server 324 compares visual characteristics of the ones of the tools 308 captured in at least one of the images with models of known tools stored in a database. Characteristics (e.g., length, type, size, etc.) of tools are also stored in the database. If the visual characteristics of one of the tools 308 used match visual characteristics of a known tool stored in the database, the server 324 may add the characteristics of the one of the tools 308 to the assembly document 312. In various implementations, the server 324 may read one or more characteristics of the one of the tools 308 from an image from the camera 320.

If the assembly document 312 does not include an order for assembling the components 208, the server 324 determines an order for assembling the components 208 used by the assembler 304 from the images from the camera 320. The server 324 may add the order for assembling the components 208 to the assembly document 312.

If the assembly document 312 does not include a position of the assembler 304, a position of one or more of the tools 308, or a position of one or more of the components 208 during the assembly of the components 208, the server 324 determines the not included position using at least one of the images from the camera 320. The server 324 may add the determined position to the assembly document 312.

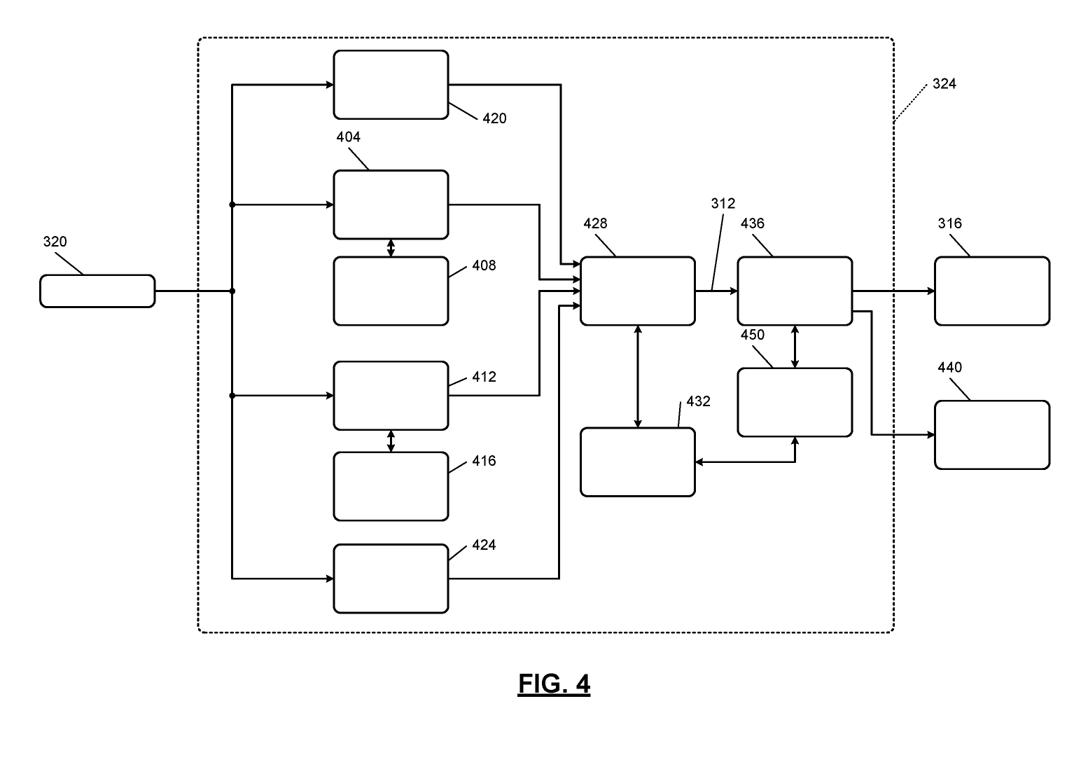

FIG. 4 is a functional block diagram of an example implementation of an assembly documentation system including the camera 320 and the server 324. The server 324 may include a component module 404, a component database 408, a tool module 412, a tool database 416, an order module 420, and a position module 424. The server 324 may also include an assembly module 428, an assembly document database 432, and an output module 436.

The assembly module 428 determines whether the assembly document 312 for the first workstation 212 is already stored in the assembly document database 432. If the assembly document 312 is already stored in the assembly document database 432, the assembly module 428 may update information in the assembly document 312 based on information learned from the images from the camera 320.

If no assembly document is stored in the assembly document database 432 for the first workstation 212, the assembly module 428 creates the assembly document 312 for the first workstation 212. The assembly module 428 may initially use a document template for the creation of the assembly document 312. Based on the components captured in the images from the camera 320, however, the assembly module 428 may identify one or more similar component assemblies and fill portions of the assembly document 312 with information from the assembly documents associated with the one or more similar component assemblies.

The component module 404, the tool module 412, the order module 420, and the position module 424 receive the images from the camera 320 at the first workstation 212. As discussed above, the camera 320 captures the images during assembly of the components 208 to produce the assembly 216. The camera 320 may capture images continuously at a predetermined rate (e.g., a predetermined number of frames per second).

The component module 404 compares visual attributes (e.g., shape, dimensions, color, markings) of the components 208 captured in at least one of the images with visual attributes of known components stored in the component database 408. A virtual model (e.g., a three-dimensional model) and information of other visual attributes is stored in the component database 408 for each known component. Unique part numbers are also associated with the known components, respectively, in the component database 408.

The component module 404 executes an image recognition algorithm to determine whether the visual attributes of a component in at least one of the images match the visual attributes of a known component. When the visual attributes of the component match the visual attributes of a known component, the component module 404 determines the part number of that component from the component database 408. Matching may refer to having at least a predetermined amount of the same visual attributes. For example, the component module 404 may identify edges of a component in one or more of the images using an edge detection algorithm and hash a file including the identified component to produce a value. The value therefore has a relationship with the visual attributes of the component. Each of the known components may also be associated with respective predetermined values in the component database 408. The component module 404 may determine that a component in one or more of the images matches a known component when the value determined for the component is within a predetermined amount of the predetermined value associated with the known component.

The assembly module 428 adds the part number of the component to the portion of the assembly document 312 involving assembly of the component. The assembly module 428 may, for example, replace a shape description of the component in the assembly document 312 with the part number of the component, add the part number of the component to the assembly document 312, or replace an existing part number included in the assembly document 312 in association with the component with the part number.

The above is performed for each of the components 208 used to assemble the first assembly 216. The addition of the part numbers of the components 208 may improve an efficiency of the manufacturing process and/or an assembly of the components 208 to produce the first assembly 216.

The tool module 412 compares visual attributes (e.g., shape, dimensions, color, markings) of the ones of the tools 308 captured in at least one of the images with visual attributes of known tools stored in the tool database 416. A virtual model (e.g., a three-dimensional model) and information of other visual attributes is stored in the tool database 416 for each known tool. Unique tool descriptions are also associated the known tools, respectively, in the tool database 416.

The tool module 412 executes an image recognition algorithm to determine whether the visual attributes of a tool in at least one of the images match the visual attributes of a known tool. When the visual attributes of the tool match the visual attributes of a known tool, the component module 404 determines the part number of that component from the tool database 416. Matching may refer to having at least a predetermined amount of the same visual attributes. For example, the tool module 412 may identify edges of a tool in one or more of the images using an edge detection algorithm and hash a file including the identified component to produce a value. The value therefore has a relationship with the visual attributes of the tool. Each of the known tools may also be associated with respective predetermined values in the component database 408. The tool module 412 may determine that a tool in one or more of the images matches a known tool when the value determined for the component is within a predetermined amount of the predetermined value associated with the known tool.

The assembly module 428 adds the unique tool description of the tool to the portion of the assembly document 312 involving assembly of the component using that tool. The assembly module 428 may, for example, replace a general description of a tool in the assembly document 312 with the determined (more specific) unique tool description, add the unique tool description of the tool to the assembly document 312, or replace an existing tool description included in the assembly document 312 in association with the tool with the determined unique tool description.

The above is performed for each of the tools used. More than one tool may be used at the same time, and the unique tool description of each of the tools may be added to the assembly document 312. For example, the assembler 304 may tighten a specific bolt (component) using a 14 millimeter (mm) socket via a ⅜″ ratchet with a 3″ extension. The addition of the unique tool descriptions of the ones of the tools 308 used may improve an efficiency of the manufacturing process and/or an assembly of the components 208 to produce the first assembly 216.

The order module 420 determines an order of assembly of the components 208 from the images from the camera 320. For example, the order module 420 may determine the order as the order in which the components 208 are identified in the images from the camera 320 during one assembly cycle. One assembly cycle may refer to the period to complete one instance of assembling the components and/or assemblies to be assembled at a workstation into the assembly or final product to be produced at the workstation.

The assembly module 428 may add the order of the assembly of the components 208 to the assembly document 312. In various implementations, the assembly module 428 may describe assembly of the components 208 in the order. The addition of the order to the assembly document 312 may improve an efficiency of the manufacturing process and/or an assembly of the components 208 to produce the first assembly 216. Also, if the assembler 304 changes the order, the change will be identified via the images, and the order will automatically be updated in the assembly document 312.

The position module 424 executes an image recognition algorithm to determine positions of the assembler 304 and positions of the ones of the tools 308 during the assembly of the components 208. The assembly module 428 adds the positions to the assembly document 312 in association with the assembly of the respective ones of the components 208 using the respective ones of the tools 308.

The addition of the positions to the assembly document 312 may improve an efficiency of the manufacturing process and/or an assembly of the components 208 to produce the first assembly 216. Also, if the assembler 304 changes positions and/or the positions of one or more of the tools (e.g., for comfort or ergonomics), the positions will automatically be updated in the assembly document 312.

The assembly module 428 saves the assembly document 312 in memory within the assembly document database 432. Additionally, the output module 436 may output the assembly document 312. For example, the output module 436 may display the assembly document 312 on one or more displays, such as the display 316. In various implementations, the output module 436 may print the assembly document 312 via a printer, such as printer 440. The assembly document 312 may be used as a reference for assemblers to follow, to teach to assemblers, and/or to program an assembler. As discussed further below, optimization may also be performed on the assembly documents to optimize one or more aspects of the manufacturing process as a whole or at one or more workstations. While the example of the first workstation 212 is provided, the above may be performed for multiple or all workstations such that an assembly document is created and formalized for multiple or all workstations of a manufacturing process. While referred to as assembly documents, the assembly documents can take the form of databases, spreadsheets, or other types of files and/or storage. Assembly documents may also include other information, such as robotic information, human ergonomic information, virtual reality (VR) information, simulation data, illustrations, computer aided design (CAD) representations, requirements (manufacturing and/or other requirements), and other types of information.

The formalized assembly documents include specific details and are computer readable. Below is an example table including details for a non-formalized assembly document and a formalized assembly document produced by the assembly module 428.

| Non-Formalized | (Formalized) Assembly documentation |
|---|---|
| Documentation | representation |
| Station 1: | Station 1 located in position X, Y, Z and |
| Operator retrieves part | orientation R, P, Y in coordinates of plant P. |
| XXX-XXXX-1 from | CAD representation of station 1 |
| container X and bolts | Operator is positioned in X, Y, Z and |
| it to assembly XXX- | orientation R, P, Y in station coordinates |
| XXXX-2 using 3 | Assembly XXX-XXXX-2 is located in |
| bolts XXX-XXXX-3 | position X, Y, Z and orientation R, P, Y in |
| and tool XXX- | station coordinates. |
| TOOL-1 | Tool XXX-TOOL-1 is located in position |
| (picture). Torque | X, Y, Z and orientation R, P, Y in station |
| <Value> | coordinates. |
| | Part container is located in position X, Y, Z |
| | and orientation R, P, Y in station coordinates. |
| | Part XXX-XXXX-1 is located position X, Y, Z |
| | and orientation R, P, Y in station coordinates. |
| | Assembler: |
| | Move into position X, Y, Z and |
| | orientation R, P, Y |
| | Position hand on part XXX-XXXX-1 in |
| | position X, Y, Z and orientation R, P, Y in |
| | station coordinates |
| | Take part XXX-XXXX-1 |
| | Move into position X, Y, Z and |
| | orientation R, P, Y in station coordinates. |
| | Place part XXX-XXXX-1 in position |
| | X, Y, Z and orientation R, P, Y in station |
| | coordinates. |
| | Take bolt XXX-XXXX-3 and place in |
| | position X, Y, Z and orientation R, P, Y in |
| | station coordinates. |
| | Take bolt XXX-XXXX-3 and place it in |
| | position X, Y, Z and orientation R, P, Y in |
| | station coordinates. |
| | Take bolt XXX-XXXX-3 and place it in |
| | position X, Y, Z and orientation R, P, Y in |
| | station coordinates. |
| | Take tool XXX-TOOL-1 (grasp location |
| | on the tool may be specified) |
| | Positions tool XXX-TOOL-1 into |
| | position X, Y, Z and orientation R, P, Y |
| | . . . |

An optimization module 450 may be configured to read the assembly documents and adjusts one or more of the assembly documents to optimize one or more aspects of the manufacturing process. For example, the optimization module 450 may adjust one or more of the assembly documents to increase throughput of the manufacturing process, decrease cost of the manufacturing process, increase ergonomics of the manufacturing process, etc. Example adjustments of the assembly documents include, but are not limited to, changing an order of assembly of components at a workstation (e.g., to increase throughput), changing an order of assembly of different workstations (e.g., to increase throughput), changing a number of workstations used to complete an assembly (e.g., to increase throughput), and changing one or more tools used at a workstation (e.g., from a custom made tool to a standard tool, such as to reduce cost). Other example adjustments of the assembly documents include, but are not limited to, changing a location of an operator during assembly at a workstation (e.g., for better ergonomics), changing a pick-up location of a component or tool at a workstation (e.g., for better ergonomics), and changing an orientation of a tool at a workstation (e.g., for better ergonomics).

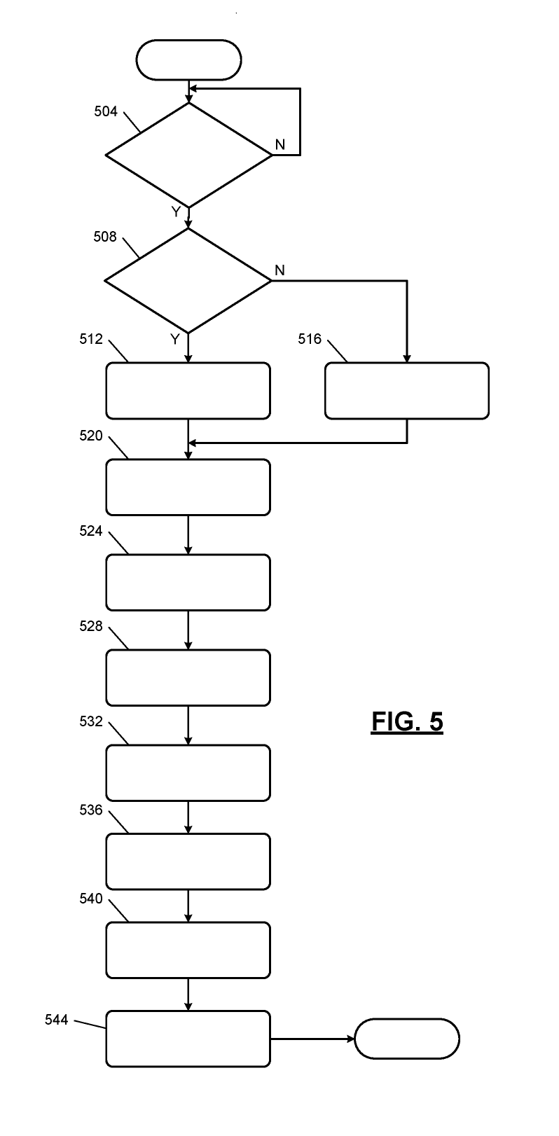

FIG. 5 includes a flowchart depicting an example method of creating or updating the assembly document 312 for the first workstation 212 using images from the camera 320. Control may begin with 504 where the assembly module 428 may determine whether a new assembly cycle is beginning based on the images from the camera 320. For example, the assembly module 428 may determine that a new assembly cycle is beginning in response to a determination that the assembler 304 has finished producing one instance of the first assembly 216. If 504 is true, control may continue with 508. If 504 is false, control may remain at 508.

At 508, the assembly module 428 may determine whether an assembly document is already stored in the assembly document database 432 for the first workstation 212. If 508 is false, the assembly module 428 creates the assembly document 312 at 516, and control may continue with 520. In various implementations, the assembly module 428 may initialize the assembly document 312 to include information from another workstation involving assembly of similar components to produce a similar assembly. If 508 is true, the assembly module 428 retrieves the assembly document 312 stored for the first workstation 212 at 512, and control continues with 520.

At 520, the component module 404 identifies the components 208 that are assembled to produce the first assembly 216 from the images from the camera 320 and image recognition. At 524, the component module 404 determines the unique part numbers for the components 208 identified, respectively.

At 528, the tool module 412 identifies the tools 308 used during the assembly from the images from the camera 320 and image recognition. At 532, the component module 404 determines the unique tool descriptions of the tools 308 identified, respectively.

At 536, the position module 424 determines the positions of the assembler 304 and the tools 308 used during the assembly from the images from the camera 320 and image recognition. At 540, the order module 420 determines the order of assembly of the components 208 from the images from the camera 320.

At 544, the assembly module 428 updates the assembly document 312 based on the unique part numbers, the unique tool descriptions, the positions, and/or the order and re-saves the assembly document 312 in the assembly document database 432. For example, the assembly module 428 may add the above to the assembly document 312 or replace more general information in the assembly document 312 (e.g., a general description of the shape of a component) with the above more particular information (e.g., the unique part number of the component). The output module 436 may output the assembly document 312 in various implementations. For example, the output module 436 may display the assembly document 312 on the display 316 and/or print the assembly document 312 from a printer 440. The updating of the assembly document 312 may improve efficiency of the manufacturing process.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

What is claimed is:

1. A manufacturing process documentation system, comprising:
a camera configured to, at a predetermined rate, capture images of an assembler during assembly of a plurality of components into an assembly using one or more tools;
a first database stored in memory, the first database including:
imaging data associated with known components; and
unique part numbers of the known components, respectively;
a component module configured to:
based on the imaging data associated with the known components and portions of the images including one of the components, identify the one of the components as one of the known components; and
determine the unique part number associated with the one of the known components;
an assembly document module configured to:
add the unique part number associated with the one of the known components to an assembly document including instructions for assembling the plurality of components into the assembly; and
store the assembly document in memory.

2. The manufacturing process documentation system of claim 1 wherein the assembly document module is configured to identify a portion of the assembly document that is associated with the one of the components and to replace one or more words included in the portion with the unique part number associated with the one of the known components.

3. The manufacturing process documentation system of claim 1 wherein:
the component module is further configured to:
based on the imaging data associated with the known components and portions of the images including a second one of the components, identify the second one of the components as a second one of the known components; and
determine the unique part number associated with the second one of the known components; and
the assembly document module is further configured to add the unique part number associated with the second one of the known components to the assembly document including instructions for assembling the plurality of components into the assembly.

4. The manufacturing process documentation system of claim 1 further comprising:
a second database stored in memory, the second database including:
imaging data associated with known tools; and
unique tool descriptions of the known tools, respectively; and
a tool module configured to:
based on the imaging data associated with the known tools and portions of the images including one of the tools, identify the one of the tools as one of the known tools; and
determine the unique tool description associated with the one of the known tools,
wherein the assembly document module is further configured to add the unique tool description associated with the one of the known tools to the assembly document including the instructions for assembling the plurality of components into the assembly.

5. The manufacturing process documentation system of claim 4 wherein the assembly document module is configured to identify a portion of the assembly document that is associated with the one of the components and to replace one or more words included in the portion with the unique tool description associated with the one of the known tools.

6. The manufacturing process documentation system of claim 4 wherein:
the tool module is further configured to:
based on the imaging data associated with the known tools and portions of the images including a second one of the tools, identify the second one of the tools as a second one of the known tools; and
determine the unique tool description associated with the second one of the known tools; and
the assembly document module is further configured to add the unique tool description associated with the second one of the known tools to the assembly document including instructions for assembling the plurality of components into the assembly.

7. The manufacturing process documentation system of claim 1 further comprising an order module configured to, based on the images, determine an order that the assembler assembled the components into the assembly,
wherein the assembly document module is configured to add the order to the assembly document including instructions for assembling the components into the assembly.

8. The manufacturing process documentation system of claim 1 further comprising a position module configured to, based on the images, determine a position of the assembler during assembly of the one of the components,
wherein the assembly document module is configured to add the position to the assembly document including instructions for assembling the components into the assembly.

9. The manufacturing process documentation system of claim 1 further comprising a position module configured to, based on the images, determine a position of one of the tools during assembly of the one of the components using the one of the tools,
wherein the assembly document module is configured to add the position to the assembly document including instructions for assembling the components into the assembly.

10. The manufacturing process documentation system of claim 1 further comprising a position module configured to, based on the images:
determine a first position of the assembler during assembly of the one of the components; and
determine a second position of one of the tools during assembly of the one of the components using the one of the tools,
wherein the assembly document module is configured to add the first position and the second position to the assembly document including instructions for assembling the components into the assembly.

11. The manufacturing process documentation system of claim 1 further comprising:
a second database stored in memory, the second database including:
imaging data associated with known tools; and
unique tool descriptions of the known tools, respectively;
a tool module configured to:
based on the imaging data associated with the known tools and portions of the images including one of the tools, identify the one of the tools as one of the known tools; and
determine the unique tool description associated with the one of the known tools; and
an order module configured to, based on the images, determine an order that the assembler assembled the components into the assembly,
wherein the assembly document module is further configured to add the unique tool description associated with the one of the known tools and the order to the assembly document including the instructions for assembling the plurality of components into the assembly.

12. The manufacturing process documentation system of claim 1 further comprising an output module configured to display the assembly document on a display located at a workstation of the assembler.

13. The manufacturing process documentation system of claim 1 further comprising an output module configured to print the assembly document from a printer.

14. The manufacturing process documentation system of claim 1 further comprising:
a second camera configured to, at a predetermined rate, capture second images of a second assembler during assembly of a second plurality of components into a second assembly using a second one or more tools,
wherein the component module is further configured to:
based on the imaging data associated with the known components and portions of the second images including one of the second plurality of components, identify the one of the second plurality of components as a second one of the known components; and
determine the unique part number associated with the second one of the known components;
wherein the assembly document module is further configured to:
add the unique part number associated with the second one of the known components to a second assembly document including second instructions for assembling the second plurality of components into the second assembly; and
store the second assembly document in memory.

15. The manufacturing process documentation system of claim 1 further comprising:
a second camera configured to, at a predetermined rate, capture second images of the assembler during assembly of the plurality of components into the assembly using the one or more tools,
wherein the component module is configured to identify the one of the components as one of the known components based on:
the imaging data associated with the known components;
the portions of the images including the one of the components; and
second portions of the second images including the one of the components.

16. A method comprising:
by a camera, at a predetermined rate, capturing images of an assembler during assembly of a plurality of components into an assembly using one or more tools;
storing, in a first database stored in memory:
imaging data associated with known components; and
unique part numbers of the known components, respectively;
based on the imaging data associated with the known components and portions of the images including one of the components, identifying the one of the components as one of the known components;
determining the unique part number associated with the one of the known components;
adding the unique part number associated with the one of the known components to an assembly document including instructions for assembling the plurality of components into the assembly; and
storing the assembly document in memory.

17. The method of claim 16 further comprising:
identifying a portion of the assembly document that is associated with the one of the components; and
replacing one or more words included in the portion with the unique part number associated with the one of the known components.

18. The method of claim 16 further comprising:
based on the imaging data associated with the known components and portions of the images including a second one of the components, identifying the second one of the components as a second one of the known components;
determining the unique part number associated with the second one of the known components; and
adding the unique part number associated with the second one of the known components to the assembly document including instructions for assembling the plurality of components into the assembly.

19. The method of claim 16 further comprising:
storing, in a second database stored in memory:
imaging data associated with known tools; and
unique tool descriptions of the known tools, respectively; and
based on the imaging data associated with the known tools and portions of the images including one of the tools, identifying the one of the tools as one of the known tools;
determining the unique tool description associated with the one of the known tools; and
adding the unique tool description associated with the one of the known tools to the assembly document including the instructions for assembling the plurality of components into the assembly.

20. The method of claim 16 further comprising:
based on the images, determining a position of the assembler during assembly of the one of the components; and
adding the position to the assembly document including instructions for assembling the components into the assembly.
